(19) United States
(12) Patent Application Publication
(10) Pub. No.: US 2013/0330578 A1
(43) Pub. Date: Dec. 12, 2013

(54) METHOD AND DEVICE FOR WARMING A TRACTION BATTERY OF A VEHICLE

(71) Applicant: Bernhard Domel, Seefeld (DE)

(72) Inventor: Bernhard Domel, Seefeld (DE)

(73) Assignee: ZF Friedrichshafen AG, Friedrichshafen (DE)

(21) Appl. No.: 13/981,642

(22) PCT Filed: Jan. 4, 2012
(86) PCT No.: PCT/EP2012/050064

§ 371 Date: Jul. 25, 2013

(30) Foreign Application Priority Data
Feb. 24, 2011 (DE) 10 2011 004 624.0

(51) Int. Cl. H01M 10/50

(52) U.S. Cl. CPC H01M 10/5006; H01M 10/5016
USPC 429/50; 429/120

(57) ABSTRACT

A method of warming a traction battery (120) of a vehicle. The vehicle comprises an inverter (130), a cooling circuit (250) by which the traction battery (120) and the inverter (130) are thermally coupled with one another, and an electric machine (140). The inverter (130) receives direct current from the traction battery (120) and converts the direct current into an alternating current which is supplied to the electric machine (140). The method includes a step in which a reactive current fraction of the alternating current is set in such manner that waste heat is produced in the inverter (130) for warming the traction battery (120) by way of the cooling circuit (250).

This application is a National Stage completion of PCT/EP2012/050064 filed Jan. 4, 2012, which claims priority from German patent application serial no. 10 2011 004 624.0 filed Feb. 24, 2011.

### FIELD OF THE INVENTION

The present invention relates to a method for warming a traction battery of a vehicle, a device for warming a traction battery of a vehicle and a drive system for a vehicle that has a corresponding device.

### BACKGROUND OF THE INVENTION

At low temperatures only very little power can be drawn from a battery, for example a lithium battery for an application in which it delivers drive power in the passenger automobile sector. When the power that can be obtained at low temperatures is drawn, inherent losses occur which, however, are not sufficient to warm the battery to a suitable operating temperature. Until now a traction battery in a vehicle has been brought to operating temperature by various means. However, these means basically entail additional cost and complexity, for example related to additional hardware.

DE 40 27 149 A1 discloses an electronic battery heating system, which is incorporated in a housing and attached to the battery by means of double-sided adhesive foil.

### SUMMARY OF THE INVENTION

Against this background the present invention provides an improved method for warming a traction battery of a vehicle, an improved device for warming a traction battery of a vehicle and an improved drive system for a vehicle. Advantageous design features emerge from the description given below.

The present invention is based on the use of reactive current for warming the coolant. The warmed cooling water is in turn used for warming the traction battery. The basic concept is that by means of the existing hardware provided for the normal driving operation of the vehicle, all or most of the power that can be obtained from the cold battery can be converted to heat. In this case, besides the traction battery the existing hardware consists of an inverter and an electric machine.

In an embodiment the electric machine is supplied with an alternating current by way of the inverter, the current resulting in little or no torque in the electric machine, but instead producing only or mainly ohmic losses in the form of waste heat. Considered from an electrical standpoint machine currents of this type are reactive currents. The switching and permeation losses of the switching elements of the inverter caused during the production of this alternating current warm up the cooling water of a cooling circuit. The inverter and the traction battery are thermally coupled to the cooling circuit and are hydraulically connected in series, so that the warmed cooling water can flow through the battery and warm it.

An advantage of the present invention is that due to the heating by means of reactive current no additional hardware cost for warming the traction battery is incurred. Consequently costs and structural installation space can be saved. Furthermore, such a battery warming system can be produced inexpensively. Since at low temperatures a traction battery has to be warmed in order to reach its full performance level, the present invention offers a possible means, even in cold-start conditions, for warming the traction battery in such manner that it can deliver its full power in the shortest possible time. Thus, there is no need to heat the water in the cooling circuit with which the traction battery is coupled by means of a standard heater built into the passenger automobile or by means of a water/water heat exchanger. Accordingly, in addition no heating elements for such a heat exchanger are needed, whether supplied from the battery or externally. Moreover, internal heating cells are not needed for the traction battery.

Then present invention provides a method for warming a traction battery of a vehicle with an inverter, a cooling circuit by means of which the traction battery and the inverter are thermally coupled and an electric machine designed to draw an alternating current from the inverter, this current being produced by the inverter from a direct current delivered by the traction battery itself, the method having the following step:

setting a reactive current from the inverter so as to produce in the inverter waste heat for warming the traction battery by way of the cooling circuit.

The vehicle can be an electrically driven vehicle, for example a land, air or water vehicle. For example it can be a passenger automobile or a truck. A traction battery provides drive power for such an electrically driven vehicle. In this case the traction battery can be an electrical energy storage device in the form of a secondary cell or an accumulator, in particular a lithium cell. The traction battery is designed to deliver a battery current which is a direct current. The inverter is designed to receive the direct current from the traction battery. The inverter is an electric device designed to convert a direct current, in this case the battery current, into an alternating current. During the conversion process losses occur in the switch elements of the inverter, which result in warming in the form of heat. A coolant in the cooling circuit can take up the waste heat produced during the alternating current conversion and give up that heat to the traction battery, thereby warming it. The alternating current converted by the inverter from the battery current can be a three-phase alternating current or rotating current. The alternating current can comprise an active current fraction and a reactive current fraction. The active current fraction from the inverter is suitable for supplying an electric machine with electric drive power. The electric machine can be an electric motor. The reactive current fraction is converted by the electric machine not into mechanical power but into heat. Accordingly, during normal operation of the electric machine the reactive current fraction is kept as small as possible. According to the invention, the reactive current fraction of the alternating current is increased to an extent greater than reasonably required for normal operation of the electric machine, in order to generate more waste heart. During this the waste heat produced by the reactive current fraction appears both in the inverter and in the electric machine. The required special phase position of the alternating current can be produced when the electric machine is at rest, for example by applying a fixed resolver angle pattern. If the machine is rotating, the phase position of the alternating current can for example be controlled by appropriate control-technological means in such manner that the desired effect of an elevated reactive current fraction is obtained.

During this, in the step of setting a reactive current fraction of the alternating current the reactive current fraction of the alternating current can be set as a function of a temperature of the traction battery. The traction battery has an optimum operating temperature range, within which the power delivered by the traction battery is maximized. If the temperature of the traction battery is actually below the optimum operating temperature range, the reactive current fraction can be increased. The higher reactive current fraction serves to warm the traction battery to a temperature within the optimum operating temperature range. The temperature is raised by heat given off by the inverter, by way of the cooling circuit to the traction battery. In this, the reactive current fraction can be set variably. This embodiment of the present invention offers the advantage that the traction battery is warmed inexpensively and efficiently.

A step of setting an active current fraction of the alternating current can also be envisaged, in order to provide mechanical drive power by means of the electric machine. The active current fraction can be converted into mechanical drive power by the electric machine. If the traction battery has to be warmed to bring its temperature within the optimum operating temperature range, then the active current fraction can be reduced in favor of a higher reactive current fraction. This embodiment of the present invention has the advantage that it can avoid damage to the traction battery caused by drawing too much power from it at too low a temperature. When the traction battery is at an optimum operating temperature, the maximum mechanical drive power is available.

In an embodiment, in the step of setting the active current fraction of the alternating current the active current fraction of the alternating current can be set to zero or nearly zero regardless of a mechanical drive power demand, if a temperature of the traction battery is lower than a specified traction battery temperature. Such a specified temperature can represent a limit value below which, to protect the battery, as little power as possible should be drawn. If the battery temperature is below the specified temperature, then the provision of active power by the inverter can be restricted. This restriction of the supply of active power can proceed far enough for the electric machine, owing to the restriction, to be capable of delivering less mechanical power than is needed for driving the vehicle. Instead, the inverter can provide more reactive current. This embodiment of the present invention has the advantage of much greater heat production efficiency, in order to bring the traction battery to its range of optimum operating temperatures as quickly as possible.

In a further embodiment, during the adjustment step a ratio between the reactive current fraction and an active current fraction of the alternating current can be set variably as a function of a temperature of the traction battery. The closer the actual temperature of the traction battery is to a desired optimum operating temperature, the higher the active current fraction can be set. This further embodiment of the present invention also has the advantage that a heat output for warming the traction battery can be adapted to an existing temperature in each case, according to need. Consequently a mixed operating mode of the electric machine is possible, in which for example part of the alternating current is used for producing torque and the remainder for purely warming. Thus, the alternating current can be adjusted variably in its torque-producing and heat-producing current fractions, namely the active and the reactive currents.

In an embodiment the electric machine is also thermally coupled with the cooling circuit. Thus, in the setting step the reactive current fraction of the alternating current can be set such that additional waste heat is produced in the electric machine for the further warming of the traction battery by way of the cooling circuit. In vehicles in which the electric machine is in the same cooling circuit as the inverter and the traction battery, the ohmic losses of the electric machine taken up by the cooling circuit can also be used for warming the traction battery. This embodiment of the present invention has the advantage of maximizing the heat produced for warming the traction battery. In this case the waste heat produced in the electric machine by the active current fraction serves the purpose of warming the traction battery. Thus, the reactive current provided by the inverter is all used for warming the traction battery.

It is also possible to provide a step in which a signal is received, with reference to which a temperature of the traction battery can be derived. The signal can be for example the output signal from a temperature sensor. The signal can indicate a temperature of the surroundings or a temperature of the traction battery. However, the signal can also indicate some other condition of the traction battery from which the temperature of the traction battery can be determined. This embodiment of the present invention has the advantage that the battery temperature can be determined reliably, so providing a monitoring possibility for monitoring whether the optimum operating temperature range of the traction battery is being kept to during operation.

The present invention also provides a device for warming a traction battery of a vehicle, which comprises an inverter, a cooling circuit by which the traction battery and the inverter are thermally coupled, and an electric machine designed to receive from the inverter an alternating current produced by the inverter from a direct current received from the traction battery, the device having the following characteristics:

a device for setting a reactive current fraction of the alternating current in order to produce in the inverter waste heat for warming the traction battery by way of the cooling circuit.

The device for warming a traction battery comprises means designed to enable a method according to the invention to be carried out advantageously.

In an embodiment wherein the electric machine is also thermally coupled with the cooling circuit, the adjustment means can be designed to set the reactive current fraction of the alternating current so as to produce in the electric machine additional heat loss for the further warming of the traction battery by way of the cooling circuit.

Furthermore, the present invention provides a drive system for a vehicle, the drive system having the following characteristics:

a traction battery for delivering a direct current;

an inverter for converting the direct current into an alternating current;

an electric machine for converting the alternating current into mechanical drive power;

a cooling circuit, by which the traction battery, the inverter and/or the electric machine are coupled; and

a device according to the invention for warming a traction battery.

In combination with the above drive system a method according to the invention can be implemented advantageously.

### BRIEF DESCRIPTION OF THE DRAWINGS

The invention will be described in greater detail, as an example, with reference to the attached drawings, which show:

FIG. 1: A schematic representation of a vehicle with a device according to an example embodiment of the present invention;

FIG. 2: A schematic representation of a drive system according to an example embodiment of the present invention; and

FIG. 3: A sequence diagram of a method according to an example embodiment of the present invention.

### DETAILED DESCRIPTION OF THE PREFERRED EMBODIMENTS

In the following description of preferred example embodiments of the present invention, the same or similar indexes are used for elements shown in the various figures that work in similar ways, so there is no need for repeated descriptions of these elements.

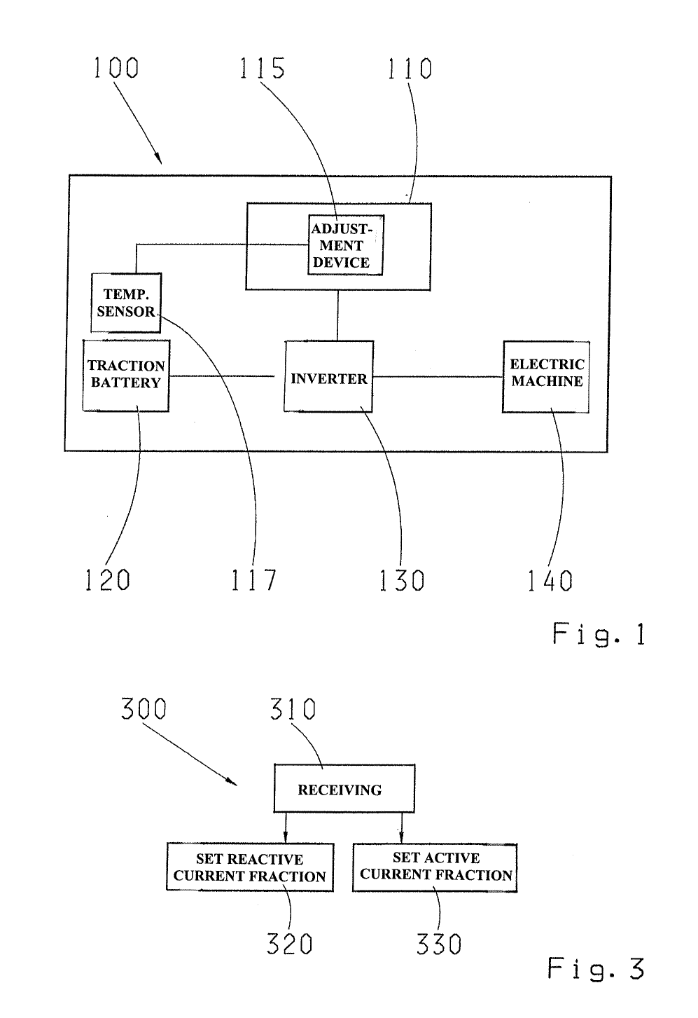

FIG. 1 shows a schematic representation of a vehicle 100 with a device 110 for warming a traction battery, according to an example embodiment of the present invention. Arranged in the vehicle 100 are the device 110, an adjustment device 115, a traction battery 120, an inverter 130 and an electric machine 140. The device 110 includes the adjustment device 115.

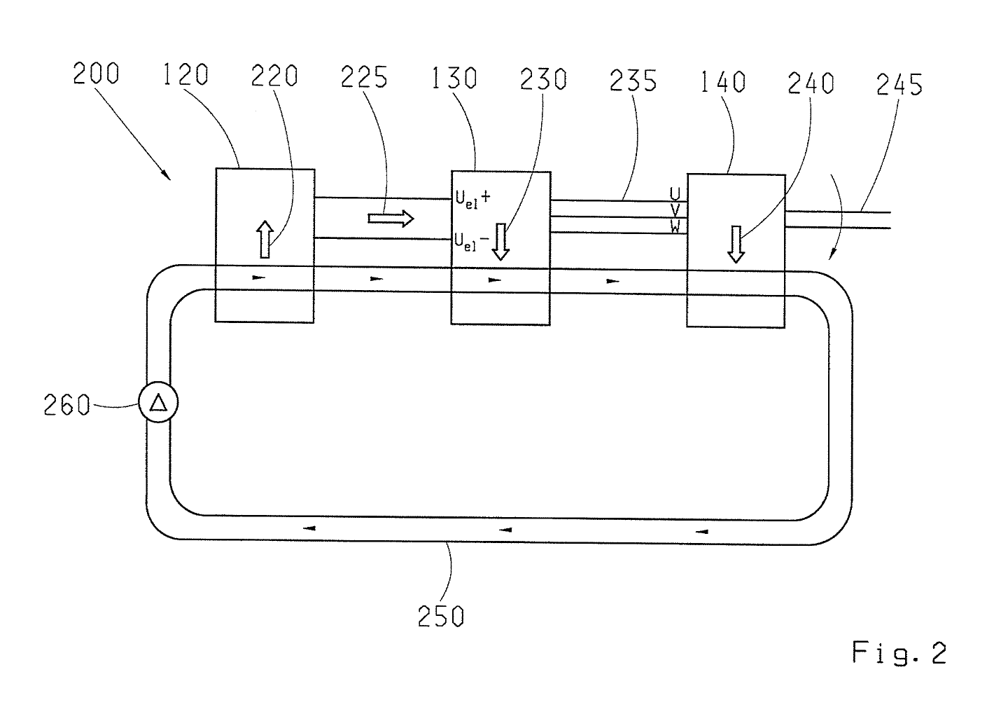

The inverter 130 is connected by means of electric lines to the device 110, the traction battery 120 and the electric machine 140. As described below with reference to FIG. 2, the traction battery 120 and the inverter 130, and optionally also the electric machine 140, are thermally coupled by means of a cooling circuit. The electric machine 140 receives from the inverter 130 an alternating current which is produced by the inverter 130 from a direct current received from the traction battery 120.

The adjustment device 115 is designed to set a reactive current fraction of the alternating current in order to produce in the inverter 130 and optionally also in the electric machine 140 more waste heat for warming the traction battery 120 by way of the cooling circuit 250. For this purpose the device 115 can be coupled to a temperature sensor 117 arranged on or close to the traction battery 120 in order to detect a temperature of the traction battery. Accordingly, the adjustment device can be designed to set the reactive current fraction as a function of the temperature of the traction battery 120.

The traction battery 120, the inverter 130, the electric machine 140, the cooling circuit (not shown in FIG. 1) and the device 110 with the device 115 form a drive system of the vehicle 100. For this, the electric machine 140 can be coupled to a transmission or a drive axle of the vehicle 100.

FIG. 2 shows a schematic representation of a drive system 200 according to an example embodiment of the present invention. The figure shows a traction battery 120, an inverter 130 and an electric machine 140. The inverter 130 is connected to the traction battery 120 and to the electric machine 140 by means of electric lines. The traction battery 120, the inverter 130 and the electric machine 140 are thermally coupled with the cooling circuit 250. The pump 260 is associated with the cooling circuit in order to circulate coolant in the cooling circuit 250. The traction battery 120 absorbs a certain heating power (P_{Heiz}) 220 and delivers a certain battery current power (P_{batt}) 225. The inverter 130 receives this battery current power (P_{batt}) 225 and gives out inverter waste heat (P_{V}_{_{—}}_{WR}) 230 and an alternating current power (P_{ac}) 235. The electric machine 140 takes up this alternating current power (P_{ac}) 235 and produces mechanical drive power (P_{mech}) 245 and machine waste heat (P_{V}_{_{—}}_{masch}) 240. The cooling circuit 250 is designed to absorb the inverter waste heat (P_{V}_{_{—}}_{WR}) 230 and machine waste heat (P_{V}_{_{—}}_{masch}) 240 and to deliver the heating power (P_{Heiz}) 220.

A coolant is circulated in the cooling circuit 250 by the pump 260 in such manner that in the flow direction of the coolant, the inverter 130 is arranged behind the traction battery 120 and the electric machine 140 behind the inverter 130. Thus, the coolant flows cyclically through the traction battery 120, the inverter 130, the electric machine 140 and the pump 260, one after another.

The traction battery 120 is electrically connected to the inverter 130 by two connection lines. For this, the inverter 130 has two terminals Uₑₗ⁺ and Uₑₗ⁻. Via the connection lines a direct current and thus the battery current power (P_{batt}) 225 are transferred from the traction battery 120 to the inverter 130. The inverter 130 is designed to convert the direct current received into alternating current. The alternating current is delivered as a three-phase alternating current with phases U, V, W from the inverter 130 to the electric machine 140. During the conversion of the direct to the alternating current inverter waste heat (P_{V}_{_{—}}_{WR}) 230 is produced, i.e. a power loss given up by the inverter 130 to the coolant in the cooling circuit 250. By virtue of the alternating current the alternating current power (P_{ac}) 235 is transferred to the electric machine 140. The inverter waste heat (P_{V}_{_{—}}_{WR}) 230 is given by the following equation:

### ti P_{V}_{_{—}}_{WR}=P_{batt}−P_{ac}.

Thus, the inverter waste heat (P_{V}_{_{—}}_{WR}) 230 is the difference between the battery current power (P_{batt}) 225 and the alternating current power (P_{ac}) 235.

The electric machine 140 is connected to the inverter 130 and receives from the inverter 130 the alternating current power (P_{ac}) 235, i.e. the three-phase alternating current with its three phases U, V, W. The electric machine 140 converts an active fraction of the alternating current power (P_{ac}) 235 into mechanical drive power (P_{mech}) 245, and some power loss in the form of machine waste heat (P_{V}_{_{—}}_{masch}) 240 is produced. A reactive fraction of the alternating current power (P_{ac}) 235 is not converted to drive power but exclusively into power loss in the form of the machine waste heat (P_{V}_{_{—}}_{masch}) 240. By means of a suitable adjustment device a ratio between the reactive fraction and the active fraction of the alternating current power (P_{ac}) can be set.

The machine waste heat (P_{V}_{_{—}}_{masch}) 240 is absorbed by the coolant in the cooling circuit 250. The machine waste heat (P_{V}_{_{—}}_{masch}) 240 is given by the following equation:

P_{V}_{_{—}}_{masch}=P_{ac}−P_{mech}.

So the machine waste heat (P_{V}_{_{—}}_{masch}) 240 is the difference between the alternating current power (P_{ac}) 235 and the mechanical drive power (P_{mech}) 245.

Consequently the cooling circuit 250 absorbs the inverter waste heat (P_{V}_{_{—}}_{WR}) 230 and the machine waste heat (P_{V}_{_{—}}_{masch}) 240 and can deliver them as heating power (P_{Heiz}) 220 to the traction battery 120 to be warmed up. Accordingly the traction battery 120 takes up this heating power (P_{Heiz}) 220 and is warmed. In this case the heating power (P_{Heiz}) 220 is given by the following equations:

P_{Heiz}=P_{V}_{_{—}}_{WR}+P_{V}_{_{—}}_{masch}=P_{batt}−P_{mech}

P_{Heiz}≈P_{batt} when P_{mech}≈0.

Thus, the heating power (P_{Heiz}) 220 is the sum of the inverter waste heat (P_{V}_{_{—}}_{WR}) 230 and the machine waste heat (P_{V}_{_{—}}_{masch}) 240. Disregarding other losses, the heating power (P_{Heiz}) 1220 in this case also corresponds to the difference between the battery current power (P_{batt}) 225 and the mechanical drive power (P_{mech}) 245. In the case when the mechanical drive power (P_{mech}) 245 is approximately zero, the expression can be simplified inasmuch as the heating power (P_{Heiz}) 220 is approximately equal to the battery current power (P_{batt}) 225. In that case the battery current power (P_{batt}) 225 available can be converted almost completely into heating power (P_{Heiz}) 220 for warming the traction battery 120. This can be done by reducing the active fraction of the alternating current power (P_{ac}) and increasing the reactive fraction of the alternating current power (P_{ac}).

FIG. 3 shows a sequence diagram of a method 300 for warming a traction battery of a vehicle, according to an example embodiment of the present invention. The method is advantageously implemented in a vehicle having an inverter, a cooling circuit by means of which the traction battery and the inverter are thermally coupled, and an electric machine. The electric machine receives an alternating current from the inverter, this current being produced by the inverter from a direct current received from the traction battery.

The method 300 has an optional step 310 in which a signal is received, with reference to which a temperature of the traction battery can be derived. The method 300 comprises a step 320 in which a reactive current fraction of the alternating current is set in order to produce waste heat in the inverter for warming the traction battery by way of the cooling circuit, without thereby driving the electric machine. The method 300 also comprises a further or alternative step 330 in which an active fraction of the alternating current is set in order to produce a required mechanical drive power by means of the electric machine.

During this, in the adjustment step 320 the reactive current fraction of the alternating current can be set as a function of a temperature of the traction battery. If the temperature of the traction battery is lower than a specified traction battery temperature, then in the adjustment step 330, regardless of the mechanical drive power required, the active fraction of the alternating current can be set at zero or nearly zero. Thus, a ratio between the reactive current fraction and an active current fraction of the alternating current can be set variably depending on the temperature of the traction battery. If the electric machine is also thermally coupled with the cooling circuit, then by virtue of the adjustment step 320 more waste heat can be produced in the electric machine for further warming of the traction battery by way of the cooling circuit.

The example embodiments described and illustrated in the figures have only been chosen as examples. Different example embodiments can be combined with one another completely or in relation to individual features. Moreover, one example embodiment can be supplemented by features of another example embodiment. Furthermore, method steps according to the invention can be repeated and carried out in a sequence other than the one described.

### INDEXES

100 Vehicle

110 Device for warming

115 Device for adjustment

117 Temperature sensor

120 Traction battery

130 Inverter

140 Electric machine

200 Drive system

220 Heating power

225 Battery current power

230 Inverter waste heat

235 Alternating current power

240 Machine waste heat

245 Mechanical drive power

250 Cooling circuit

260 Pump

300 Method for warming a traction battery of a vehicle

310 Receiving step

320 Step of setting a reactive current fraction

330 Step of setting an active current fraction

1-10. (canceled)

11. A method (300) of warming a traction battery (120) of a vehicle (100) having an inverter (130), an electric machine (140), and a cooling circuit (250), which thermally couples the traction battery (120) and the inverter (130) with one another, the inverter (130) converting a direct current, received from the traction battery (120), into an alternating current which is conveyed, from the inverter (130), to the electric machine (140), the method (300) comprising the steps of:
setting (320) a reactive current fraction of the alternating current to produce waste heat in the inverter (130); and
warming the traction battery (120) with the waste heat supplied to inverter (130) by way of the cooling circuit (250).

12. The method (300) according to claim 11, further comprising the step of:
setting (320) the reactive current fraction of the alternating current as a function of a temperature of the traction battery (120).

13. The method (300) according to claim 11, further comprising the step of:
setting (330) an active fraction of the alternating current; and
providing mechanical drive power by driving the electric machine (140) with the active fraction of the alternating current.

14. The method (300) according to claim 13, further comprising the step of:
setting (330) the active current fraction of the alternating current either at zero, or nearly zero, regardless of a required mechanical drive power, if a temperature of the traction battery (120) is lower than a specified traction battery temperature.

15. The method (300) according to claim 11, further comprising the step of:
variably setting (320, 330) a ratio between the reactive current fraction and an active current fraction of the alternating current as a function of a temperature of the traction battery (120).

16. The method (300) according to claim 11, further comprising the step of:
thermally coupling the electric machine (140) with the cooling circuit (250);
setting (320) the reactive current fraction of the alternating current so as to generate additional waste heat in the electric machine (140) for further warming of the traction battery (120) by way of the cooling circuit (250).

17. The method (300) according to claim 11, further comprising the step of:
receiving (310) a signal with reference to which a temperature of the traction battery (120) is derived.

18. A device (110) for warming a traction battery (120) of a vehicle (100), the device comprising:
an inverter (130) receiving a direct current from the traction battery (120),
a cooling circuit (250) by which the traction battery (120) and the inverter (130) being thermally coupled with one another, and
an electric machine (140) designed to receive an alternating current from the inverter (130) which is converted, by the inverter (130), from the direct current received from the traction battery (120); and
an adjustment device (115) for setting a reactive current fraction of the alternating current in order to produce, in the inverter (130), waste heat for warming the traction battery (120) via the cooling circuit (250).

19. The device (110) according to claim 18, wherein the electric machine (140) is thermally coupled with the cooling circuit (250); and
the adjustment device (115) is designed to set the reactive current fraction of the alternating current such that additional waste heat is produced in the electric machine (140) for further warming of the traction battery (120) by way of the cooling circuit (250).

20. A drive system (200) for a vehicle (100) in combination with a warming device, the drive system comprising:
a traction battery (120) which supplies a direct current;
an inverter (130) communicating with the traction battery for receiving the direct current therefrom, and the inverter converting the direct current into an alternating current;
an electric machine (140) communicating with the inverter so as to receive the alternating current from the inverter, and the electric machine converting the alternating current into mechanical drive power;
a cooling circuit (250) being coupled with the traction battery (120), the inverter (130) and the electric machine (140);
the warming device (110) for warming the traction battery (120) of the vehicle (100); and
an adjustment device (115) for setting a reactive current fraction of the alternating current in order to produce, in the inverter (130), waste heat for warming the traction battery (120) by way of the cooling circuit (250).
